(19) United States
(12) Patent Application Publication
(10) Pub. No.: US 2006/0254975 A1
(43) Pub. Date: Nov. 16, 2006

(54) Filter element

(75) Inventors: Michael Wolf, Neunkirchen (DE); Horst Croissant, Hochstadt (DE); Norbert Strassenberger, Adlkofen (DE); Udo Wagner, Marklkofen (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/411,956

(22) Filed: Apr. 27, 2006

(30) Foreign Application Priority Data
May 10, 2005 (DE) 202005007637.6

(51) Int. Cl. B01D 27/00

(52) U.S. Cl. 210/450; 210/488; 210/455

(57) ABSTRACT

A filter element for filtering a fluid, particularly oil, in which the filter element has at least two individual elements (10), that are interconnected by a connector (11). The individual elements (10) each include two end disks (13) and a filter medium (12) arranged therebetween. The connector (11) has a radially circumferential sealing bead (23), which communicates with the end disk (13) of an individual element (10) so as to form a seal and ensures a tight seal between the individual element (10) and the connector (11).

### BACKGROUND OF THE INVENTION

The invention relates to a filter element for filtering a fluid, particularly oil, having at least two individual elements that are interconnected by a connector.

U.S. Pat. No. 2,313,307 (=GB 542,339) discloses a filter element that is composed of a plurality of individual elements. The individual elements each have two end disks and a filter medium and are interconnected by a connector. The connector is a tubular member and has a cylindrical center section. The connector is conical in the region of the end faces, such that the cone tapers toward the end face. To connect the individual elements, the connector is inserted into the end disk, so that the cone interlocks with the end disks. To this end, the end disk is provided with corresponding clips. To prevent unfiltered fluid from flowing between the individual elements, an additional seal is disposed in the region of the cylindrical center section and is clamped axially between the individual elements. A drawback in this embodiment is that the individual elements must always be axially prestressed to ensure a tight seal between the individual elements. The additional assembly time required and the costs for the seal are a further drawback.

### SUMMARY OF THE INVENTION

It is an object of the invention to provide an improved filter element for filtering a liquid.

Another object of the invention is to provide a filter element which does not require axial prestress.

A further object of the invention is to provide a filter element which can be quickly assembled at minimal cost.

These and other objects are achieved in accordance with the present invention by providing a filter element for filtering a fluid comprising at least two individual elements interconnected by a connector, wherein the individual elements each comprise two end disks and a filter medium arranged between the end disks, and wherein the connector has a radially circumferential sealing bead which sealingly engages an end disk of an individual element.

The filter element according to the invention is intended to filter a liquid, particularly oil, or a gaseous fluid. The filter element comprises at least two interconnected individual elements. By connecting a plurality of individual elements it is possible to produce filter elements of any length and to combine mass-produced, inexpensive standard elements. This reduces the number of different filter element sizes which must be produced and maintained in inventory. Connecting the individual elements into a long filter element gives the filter element relatively great stability. Each individual element comprises two end disks and an annularly closed filter medium disposed therebetween. The filter medium can be made, for example, from cellulose paper, a nonwoven glass fiber material, a nonwoven polyester material, a laminated and/or multilayer construct or a combination of different fiber materials. The filter medium may, for example, be wound or fan-folded and annularly closed.

The end disks are tightly connected to the filter medium. Preferably, the end disks are constructed as circular annular disks. In advantageous embodiments, the end disk is made of a flexible material with adequate shape stability. Synthetic resin materials, such as thermoplastics or elastomers are suitable for this purpose, for example. In one advantageous embodiment, the end disk is made of a thermally reactive rubber, particularly nitrile rubber.

The individual elements are interconnected by a connector, which has a circumferential sealing bead. The interior of the tubular connector is permeable to the fluid to be filtered. Both the interior and the exterior can have any geometric configuration. The connector can have any cross section, e.g., rectangular, elliptical, triangular or polygonal. The sealing bead may be disposed either on the lateral surface and face outward or in the interior and face inward. If disposed on the lateral surface, the sealing bead communicates with an opening in the end disk. If disposed in the interior, the sealing bead communicates with the outer surface of the end disk.

The sealing bead communicates with the end disk of an individual element so as to form a seal, whereby a linear or planar contact is produced between the end disk and the connector. A radial seal running along the circumference is produced in this region. Because a relatively elastic end disk is paired with a relatively rigid connector, the sealing bead presses into the end disk to produce a reliable seal between the end disk and the connector.

It is advantageous if the connector has a latching ring in the form of an undercut, for example, which fixes the connector in its position and prevents it from falling out during handling.

According to another advantageous embodiment of the invention, the cylindrical connector is inserted into the end disk of the individual element. The sealing bead has an outside diameter (D) greater than the inside diameter (d) of the end disk. The elasticity of the end disk allows the inside diameter to expand slightly, so that the sealing bead can be pushed into the inside diameter of the end disk. As a result of the elasticity of the end disk, the inside diameter of the end disk fits tightly against the sealing bead of the connector to form a seal.

It is advantageous if the connector comprises an intermediate disk disposed between two sealing beads. This prevents the end disks of the individual elements from being pushed over the sealing bead or the region provided for mounting. In this embodiment the individual elements are pushed onto the connector, such that the intermediate disk serves as a limit stop for the respective end disk. This ensures that the end disk is positioned exactly on the sealing bead and cannot slip once it is mounted.

According to yet another advantageous embodiment of the invention, the diameter of the intermediate disk substantially corresponds to the outside diameter of the end disk. Thus, the end disk of each individual element can contact and rest against the intermediate disk over its full area.

According to yet another advantageous embodiment of the invention, the intermediate disk is non-releasably coupled, particularly adhesively bonded, to the adjoining end disks to produce a firm union between the mating members (end disk and connector). This prevents the individual elements from accidentally slipping off the connector.

In another advantageous embodiment, the filter element has individual elements that are provided with insertion members on the end faces opposite the connector. These insertion members communicate with the end disk to form a seal. The insertion members may be constructed as a cover or a connection for the individual element. As described above with reference to the connector, the insertion member may include a cylindrical region with a sealing bead. The sealing bead of the insertion member can have the same features as the connector.

In another embodiment of the novel filter element, the insertion member is non-releasably connected to the end disk. Thus, the insertion member cannot become accidentally detached from the end disk because of unfavorable pressure conditions inside the filter element.

### BRIEF DESCRIPTION OF THE DRAWINGS

The invention will be described in further detail hereinafter with reference to illustrative preferred embodiments shown in the accompanying drawing figures, in which:

FIG. 1 is a partially sectional view of a filter element according to the invention;

FIG. 2 is an enlarged detail view of the filter element shown in FIG. 1, and

FIG. 3 is an even more enlarged detail of the filter element of FIG. 1.

### DETAILED DESCRIPTION OF PREFERRED EMBODIMENTS

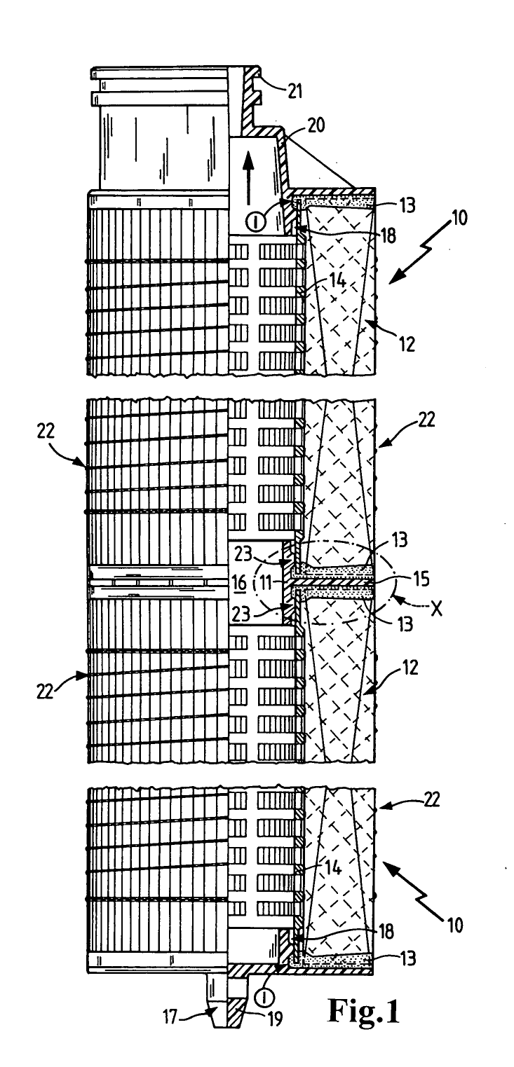

The filter element depicted in FIG. 1, which is preferably used for filtering liquids, such as oils, comprises two individual elements 10 that are interconnected by a connector 11. The individual elements 10 each have a fan-folded or pleated filter medium 12, which is annularly closed. The filter medium 12 is encircled by a spirally wound cord 22, which is fixed to the tips of the folds of the filter medium 12 by a hot-melt adhesive. End disks 13 are arranged on the end faces of the filter medium 12 and are connected to the filter medium 12 so as to form a seal.

The end disks 13, which are configured as circular annular disks, have an elasticity that allows the inside diameter I to expand. Within the annularly closed filter medium 12 is disposed a support tube 14, which supports the filter medium 12 and is permeable to the fluid to be filtered or the filtered fluid. The support tube 14 is likewise connected to the end disk 13 so as to form a seal. In this embodiment, the end disk 13 is made of a nitrile rubber, such that the filter medium 12 and the support tube 14 are enclosed by the material of the end disk 13 at their end faces.

The individual elements 10 are coupled to the connector 11, such that the connector is inserted into the inside diameter of the end disks 13. The connector 11 comprises an intermediate disk 15 with the same or substantially the same outside diameter as the end disks 13. The connector 11 furthermore has a tubular section with a fluid-permeable interior 16. In this embodiment the interior 16 is a hollow cavity. In other embodiments (not shown) the interior 16 may have struts or structures to increase stability. The interior 16 may also have a filling (not shown), which is permeable to the fluid and can serve as an additional filter unit.

A cover member 17 that closes the end face of the individual element 10 is disposed on the end disk 13 of the individual element 10 that is not connected to the connector 11. The cover member 17 is preferably made of a thermoplastic material. On its one side the cover member 17 has an insertion diameter 18, which is inserted into the inside diameter I of the end disk 13. On the other side the cover member 17 has a centering device 19, which may be positioned and secured inside a housing (not shown). The cover member 17 is non-releasably bonded to the end disk 13 to prevent accidental detachment of the cover member 17.

The other individual element 10 has a coupling member 20, which is non-releasably connected to the end disk 13. For this purpose, the coupling member 20 is inserted with its insertion diameter 18 into the inside diameter I of the end disk 13 and is bonded to the end disk. The coupling member 20 has a fitting 21, which is connectable to a filtered fluid line (not shown).

The fluid to be filtered flows radially through the individual elements 10 of the filter element from the outside to the inside. The cord 22 fixes the folds of the filter medium 12 to prevent them from contacting each other. The filtered fluid is located in the annular space enclosed by the filter medium 12. The fluid filtered by the lower individual element 10 flows through the interior 16 of the connector 11 into the annular space of the upper individual element 10. From this upper annular space the fluid flows out of the filter element through the coupling member 20 and the fitting 21.

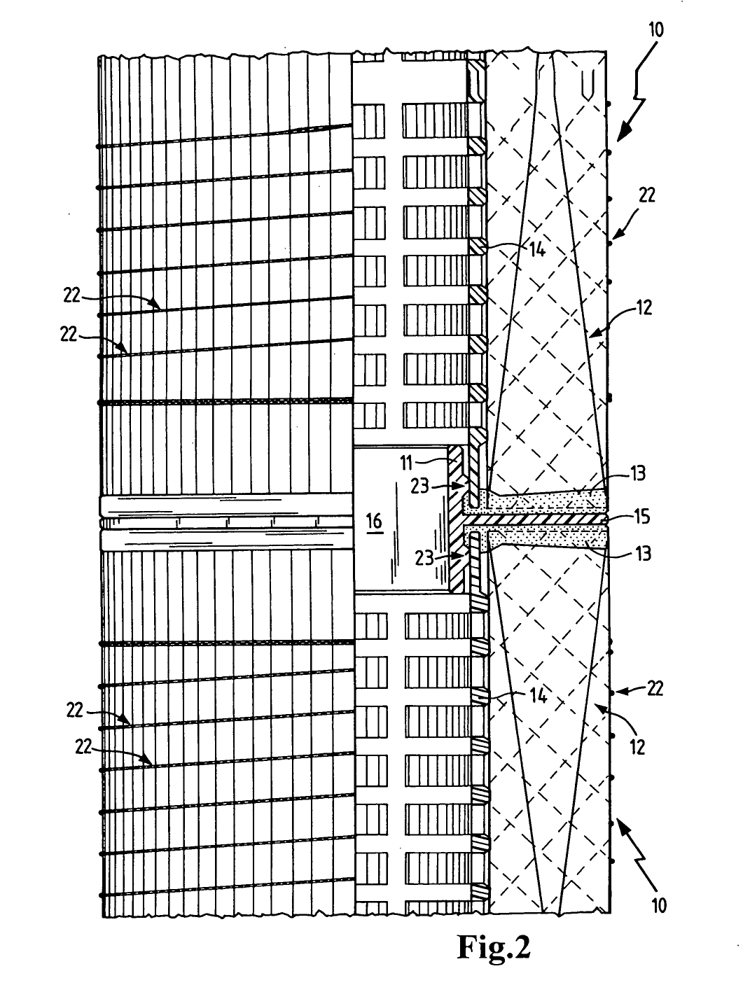

FIG. 2 shows a partially cutaway detail of the filter of FIG. 1 in the region around the connector 11. Components corresponding to those of FIG. 1 are identified by the same reference numerals. The connector 11 has two sealing beads 23 disposed on both sides of the intermediate disk 15. The sealing bead 23 communicates with the end disk 13 placed onto the connector 11 so as to form a seal. Because of its elasticity the end disk 13 expands somewhat during assembly, so that the sealing bead 23 is seated against the end disk 13 to form a seal. The intermediate disk 15 is bonded over its full area to each of the outer faces of the end disks 13, so that the connector 11 cannot detach itself from the individual element 10.

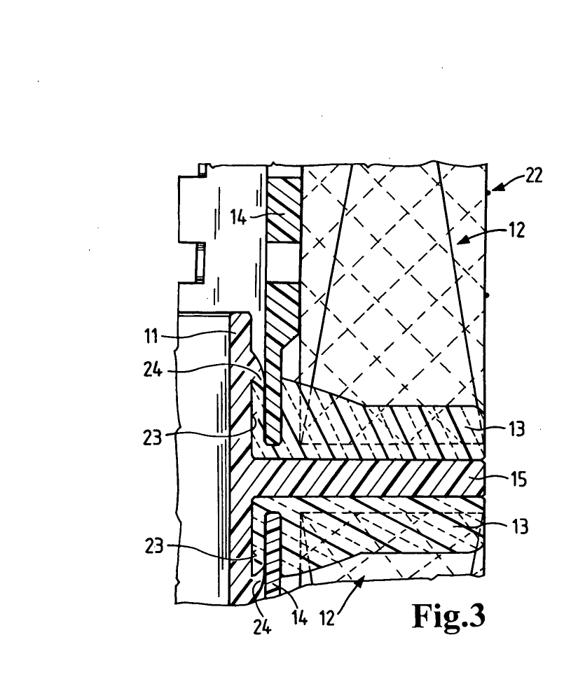

FIG. 3 is a partially cutaway view of an enlarged detail X of FIG. 1 showing the region around the connector 11. Again, components corresponding to those depicted in FIG. 1 are identified by the same reference numerals. The connector 11 has an additional latching ring 24 in the form of an undercut in the material of the connector 11. This latching ring 24 interlocks with the end disk 13 as it is connected to the individual element 10. This fixes the connector 11 in its position relative to the individual elements 10 and prevents the connector 11 from falling out during handling of the filter element. If the filter element is handled incorrectly or if the connector 11 is separated from the individual element 10 by force, the end disk 13 may be destroyed. This is an additional safety aspect because it virtually precludes used individual elements from being reused. It is also advantageous that once the individual elements are mated with the connector, the parts can no longer become detached, which enhances handling safety.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A filter element for filtering a fluid comprising at least two individual elements interconnected by a connector, wherein the individual elements each comprise two end disks and a filter medium arranged between the end disks, wherein the connector has a radially circumferential sealing bead which sealingly engages an end disk of an individual element.

2. A filter element according to claim 1, wherein the sealing bead has an outside diameter which is greater than an inside diameter of the engaged end disk of the individual element, and the connector is inserted into the engaged end disk.

3. A filter element according to claim 1, further comprising a latching ring which fixes the connector in position with the bead engaging the engaged end disk.

4. A filter element according to claim 1, wherein the connector comprises an intermediate disk which is arranged between two sealing beads on the connector.

5. A filter element according to claim 4, wherein the intermediate disk has a diameter which substantially corresponds to the outside diameter of the engaged end disk.

6. A filter element according to claim 4, wherein the intermediate disk is non-releasably connected to adjacent end disks of the two individual elements.

7. A filter element according to claim 6, wherein the intermediate disk is adhesively bonded to the adjacent end disks of the two individual elements.

8. A filter element according to claim 1, wherein the individual element end faces remote from the connector comprise insertion members which sealingly engage adjacent individual element end disks.

9. A filter element according to claim 8, wherein each insertion member comprises a cylindrical region on which a sealing bead is disposed.

10. A filter element according to claim 8, wherein each insertion member is non-releasably connected to the adjacent individual element end disk.

11. A filter element according to claim 1, wherein said fluid is motor oil.
